(19) United States
(12) Patent Application Publication
(10) Pub. No.: US 2013/0116497 A1
(43) Pub. Date: May 9, 2013

(54) Coupling Systems For Implantable Prosthesis Components

(71) Applicants: Jan Vermeiren, Mechelen (BE); Patrik Kennes, Mechelen (BE); Gerald Dumm, Regensburg (DE); Karl Everaert, Mechelen (BE)

(72) Inventors: Jan Vermeiren, Mechelen (BE); Patrik Kennes, Mechelen (BE); Gerald Dumm, Regensburg (DE); Karl Everaert, Mechelen (BE)

(73) Assignee: Cochlear Limited, Sydney (AU)

(21) Appl. No.: 13/291,166

(22) Filed: Nov. 8, 2011

(51) Int. Cl. H04R 25/00

(52) U.S. Cl. 600/25

(57) ABSTRACT

Disclosed are coupling systems for implantable prosthesis components, including implantable microphones and implantable actuators associated with prostheses including hearing prostheses. Some embodiments include a flexible elongate member having a first end mechanically coupled to a vibrating structure of a prosthesis recipient's body and a second end secured to a diaphragm, where the flexible elongate member is configured to transfer vibrations between the vibrating structure and the diaphragm. Microphone embodiments further include a vibration sensor configured to detect vibrations of the diaphragm and generate electrical signals based at least in part on the detected vibrations. Actuator embodiments include an actuation mechanism configured to apply mechanical vibration signals to a vibrating structure of the recipient's body via the elongate member by causing the first diaphragm to vibrate, where the mechanical vibration signals are based on electrical signals received from a sound processor associated with the prosthesis.

### BACKGROUND

Various types of hearing prostheses may provide persons with different types of hearing loss with the ability to perceive sound. Hearing loss may be conductive, sensorineural, or some combination of both conductive and sensorineural hearing loss.

Conductive hearing loss typically results from a dysfunction in any of the mechanisms that ordinarily conduct sound waves through the outer ear, the eardrum, or the bones of the middle ear. Persons with some forms of conductive hearing loss may benefit from hearing prostheses such as acoustic hearing aids, bone anchored hearing aids, direct acoustic stimulation prostheses, or other types of vibration-based hearing prostheses.

Sensorineural hearing loss typically results from a dysfunction in the inner ear, including the cochlea where sound vibrations are converted into neural signals, or any other part of the ear or auditory nerve, that may process the neural signals. Persons with some forms of sensorineural hearing loss may benefit from hearing prostheses such as cochlear implants and auditory brain stem implants.

In some situations, it may be desirable to fully implant one or more components of the above-described hearing prostheses into the prosthesis recipient.

### SUMMARY

The present disclosure includes a description of various coupling systems for use with implantable microphones and implantable actuators associated with medical prostheses. In some embodiments, the medical prosthesis is a hearing prosthesis, such as a cochlear implant, a direct acoustic stimulation prosthesis, an auditory brain stem implant, an acoustic hearing aid, a bone anchored hearing aid or other type of vibration-based hearing prosthesis configured to transmit sound via direct vibration of teeth or other cranial or facial bones, an auditory brain stem implants, a hybrid prosthesis, or any other type of hearing prosthesis.

In some embodiments, the prosthesis includes a flexible elongate member having a first end mechanically coupled to a vibrating structure of a prosthesis recipient's body and a second end secured to a diaphragm. The flexible elongate member is configured to transfer vibrations between the vibrating structure and the diaphragm. The vibrating structure of the recipient's body may be any structure in the recipient's middle or inner ear, such as an eardrum, a malleus, an incus, a stapes, an oval window of the recipient's inner ear, a round window of the recipient's inner ear, a horizontal canal of the recipient's inner ear, a posterior canal of the recipient's inner ear, and a superior canal of the recipient's inner ear.

For microphone embodiments, the prosthesis may further include a vibration sensor configured to detect vibrations of the diaphragm and generate electrical signals based at least in part on the detected vibrations. The vibration sensor may be an electret microphone, an electromechanical microphone, a piezoelectric microphone, a MEMS microphone, an accelerometer, an optical interferometer, a pressure sensor, or any other type of vibration sensor.

For actuator embodiments, the prosthesis may further include an actuation mechanism configured to apply mechanical vibration signals to the vibrating structure of the recipient's body via the flexible elongate member by causing the diaphragm to vibrate. The mechanical vibration signals generated by the actuation mechanism are based on signals received from a sound processor associated with the prosthesis. Some prostheses may include one or more microphones and one or more actuators according to some of the disclosed embodiments.

In some embodiments, the first end of the flexible elongate member includes a contact. The contact may be a ball-shaped contact, a flat contact, a U-shaped contact, a contact shaped to receive the vibrating structure of the prosthesis recipient's body, or any other type of contact configured to transmit vibration between the contact and the vibrating structure of the prosthesis recipient's body.

In some embodiments, the contact may be secured to the vibrating structure with a biocompatible bonding agent such as bone cement. The contact may alternatively be mechanically coupled to the vibrating structure via a fixture that includes a socket configured to mechanically receive the contact. The fixture in some embodiments is secured to the vibrating structure of the recipient's body with bone cement. In some embodiments, the socket may be formed from bone cement.

The flexible elongate member is a solid but flexible wire in some embodiments. In other embodiments, the flexible elongate member is a coil-shaped flexible wire, where at least a portion of the coil-shaped flexible wire is configured to receive bone cement during implantation. The bone cement later hardens and reduces the flexibility of the elongate member. In further embodiments, the flexible elongate member includes at least one curved portion. In still further embodiments, the flexible elongate member comprises one or more rigid portions and one or more flexible portions. In even further embodiments, the flexible elongate member includes a set of one or more interconnected adjustable portions, such as ball-and-socket joints and/or hinges.

Alternative embodiments include internal and/or external support structures alone or in combination with flexible and/or rigid elongate members.

In alternative embodiments that include an internal support structure, a hearing prosthesis has an elongate member with a first end mechanically coupled to a vibrating structure of a prosthesis recipient's body and a second end attached to a first diaphragm. The elongate member is configured to transfer vibrations between the vibrating structure and the first diaphragm. The internal support structure is mechanically coupled to the first diaphragm and a second diaphragm. In operation, the internal structure is configured to transfer vibrations between the first diaphragm and the second diaphragm and to limit radial movement of the elongate member.

In alternative embodiments that include an external support structure, a hearing prosthesis has an elongate member with a first end mechanically coupled to a vibrating structure of a prosthesis recipient's body and a second end attached to a diaphragm. The elongate member is configured to transfer vibrations between the vibrating structure and the diaphragm. The external support structure at least partially encloses at least a portion of the elongate member so as to limit radial movement of the elongate member.

### BRIEF DESCRIPTION OF THE DRAWINGS

FIG. 1 shows a high-level block diagram example of a hearing prosthesis according to some embodiments.

FIG. 2A shows an example of a microphone with a flexible elongate member for use with a hearing prosthesis.

FIG. 2B shows an example of an actuator with a flexible elongate member for use with a direct acoustic stimulation prosthesis.

FIGS. 3A-D show examples of mechanically coupling a flexible elongate member to a vibrating structure of a prosthesis recipient's middle or inner ear according to some embodiments.

FIGS. 4A-F show example configurations of elongate members according to some embodiments.

FIGS. 5A-B show cross-section views of example microphones according to some embodiments.

FIG. 6 shows a cross-section view of an example actuator according to some embodiments.

### DETAILED DESCRIPTION

The following detailed description discloses various features and functions of various embodiments with reference to the accompanying figures. The figures are for illustration purposes and are not necessarily drawn to scale. In the figures, similar symbols typically identify similar components, unless context dictates otherwise. The example embodiments described herein are not meant to be limiting. Certain aspects of the example embodiments can be arranged and combined in a wide variety of different configurations, all of which are contemplated herein.

Certain aspects of the example embodiments may be described herein with reference to cochlear implant and direct acoustic stimulator embodiments. However, the claims are not so limited. Many of the features and functions described with respect to the cochlear implant and direct acoustic stimulator embodiments may be equally applicable to other embodiments that may include other types of hearing prostheses, such as, for example, acoustic hearing aids, bone anchored hearing aids or other types of vibration-based hearing prostheses configured to transmit sound via direct vibration of teeth or other cranial or facial bones, auditory brain stem implants, or any other type of hearing prosthesis. Additionally, certain features and functions may be applicable to other types of medical prostheses as well.

Hearing Prosthesis

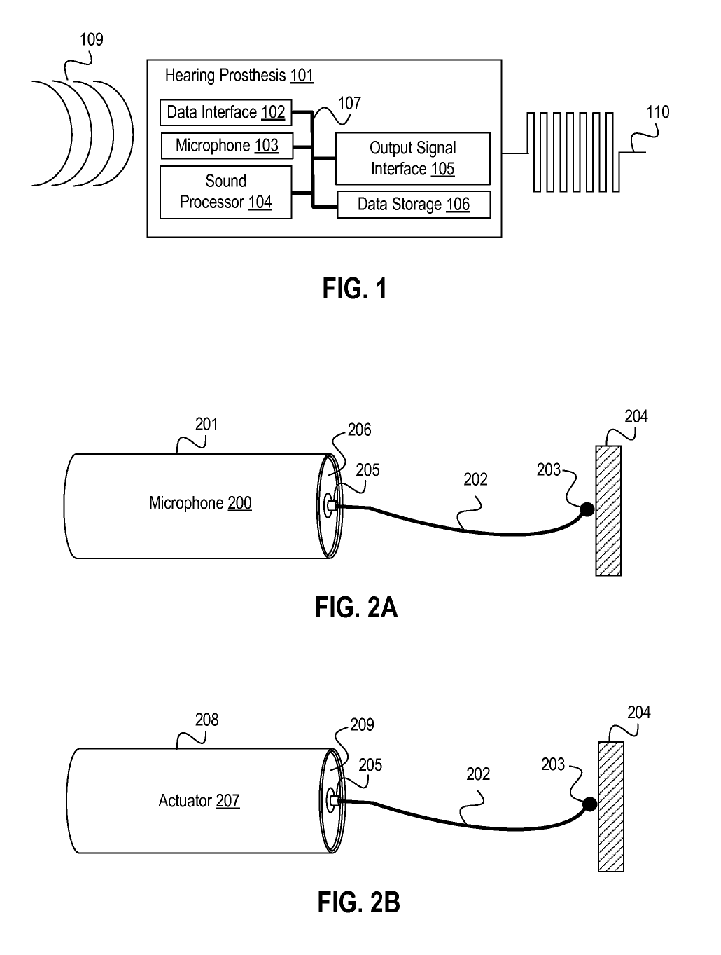

FIG. 1 shows a high-level block diagram example of a hearing prosthesis 101 according to some embodiments. The hearing prosthesis 101 may be a cochlear implant, an acoustic hearing aid, a bone anchored hearing aid or other vibration-based hearing prosthesis, a direct acoustic stimulation prosthesis, an auditory brain stem implant, or any other type of hearing prosthesis now known or later developed that is configured to aid a prosthesis recipient in hearing sound.

The hearing prosthesis 101 includes a data interface 102, a microphone 103, a sound processor 104, an output signal interface 105, and data storage 106, all of which may be connected directly or indirectly via circuitry 107. In some embodiments, the hearing prosthesis 101 may have additional or fewer components than the prosthesis shown in FIG. 1. Additionally, the components may be arranged differently than shown in FIG. 1. For example, depending on the type and design of the hearing prosthesis, the illustrated components may be enclosed within a single operational unit or distributed across multiple operational units (e.g., and external unit, a second external unit, an internal unit, a second internal unit, etc.).

The data interface 102 may be any type of wired or wireless communications interface now known or later developed that can be configured to send and/or receive data. In operation, the data interface 102 is configured to send and/or receive data to and/or from an external computing device. The data sent from the external computing device to the hearing prosthesis 101 may be configuration data for the hearing prosthesis 101. The data sent from the hearing prosthesis 101 to the external computing device may be telemetry measurements taken by the prosthesis (in some embodiments) and/or data associated with the operation and function of the hearing prosthesis 101. Other data could be sent to and/or from the hearing prosthesis 101 via the data interface 102 as well.

The data storage 106 can be any type of non-transitory, tangible, computer readable media now known or later developed that can be configured to store program code for execution by the hearing prosthesis 101 and/or other data associated with the hearing prosthesis 101.

The microphone 103 of the hearing prosthesis 101 may be an external microphone, a partially-implanted microphone, or a fully-implanted microphone. In embodiments with external microphones and partially-implanted microphones, the microphone 103 may be configured to detect external sound waves 109 and generate electrical signals based at least in part on the external sound waves 109 for analysis by the sound processor 104.

In embodiments with fully-implanted microphones, the microphone 103 may be configured to detect vibrations and/or pressure changes inside the recipient's body. The vibrations and/or pressure changes may be based on external sound waves 109. For example, for a recipient having at least a partially functional middle ear, certain structures in the recipient's middle ear may vibrate in response to (or at least based on) external sound waves 109. Similarly, for a recipient having at least a partially functional inner ear, certain structures and/or cavities in the recipient's inner ear may vibrate or exhibit changes in pressure in response to (or at least based on) external sound waves 109. In embodiments with fully-implanted microphones, the microphone 103 may be configured to detect vibrations of certain middle and/or inner ear structures and/or pressure changes in certain inner ear cavities and structures, and then convert those detected vibrations and/or pressure changes into electrical signals that are indicative of the external sound waves 109 that caused the detected vibrations and/or pressure changes in the recipient's middle and/or inner ear.

The sound processor 104 is configured to receive electrical signals from the microphone 103, and generate instructions for generating and applying the output signals 110 to the recipient's ear via the output signal interface 105. The output signal interface 105 is configured to generate and apply the output signals 110 to the recipient's ear based on the instructions received from the sound processor 104.

In embodiments where the hearing prosthesis 101 is a cochlear implant, the output signal interface 105 may include an array of electrodes, and the output signals 110 may be a plurality of electrical stimulation signals applied to the recipient's cochlea via the array of electrodes (not shown). In embodiments where the hearing prosthesis 101 is a direct acoustic stimulator, the output signal interface 105 may include a mechanical actuator, and the output signals 110 may be a plurality of mechanical vibrations applied to the recipient's middle and/or inner ear via the mechanical actuator (not shown). In embodiments where the hearing prosthesis 101 is an acoustic hearing aid, the output signals interface 105 may be a speaker, and the output signals 110 may be a plurality of acoustic signals applied to the recipient's outer or middle ear via the speaker (not shown). In embodiments where the hearing prosthesis 101 is a bone-anchored hearing aid or other type of mechanical vibration based hearing prosthesis, the output signal interface 105 may include a mechanical actuator (not shown), and the output signals 110 may be a plurality of mechanical vibrations applied to the recipient's skull, teeth, or other cranial and/or facial bone via the mechanical actuator. In embodiments wherein the hearing prosthesis 101 is an auditory brain stem implant, the output signal interface 105 may include an array of electrodes, and the output signals 110 may be a plurality of electrical signals applied to the recipient's brain stem via the array of electrodes.

FIG. 2A shows an example of a microphone 200 with a flexible elongate member 202 for use with a hearing prosthesis, such as prosthesis 101 shown in FIG. 1. The microphone 200 may be at least partially implanted in the prosthesis recipient's body. In some embodiments, the microphone 200 is fully implanted within the recipient's body. The microphone 200 includes a biocompatible housing 201, a diaphragm 206, and a flexible elongate member 202 having a first end 203 and a second end 205. The first end 203 of the flexible elongate member 202 is mechanically coupled to a vibrating structure 204 of a prosthesis recipient's body and the second end 205 of the flexible elongate member 202 is secured to the diaphragm 206.

The diaphragm 206 of the microphone 201 is flexible and configured to vibrate. The thickness of the diaphragm 206 may be based on the material that the diaphragm 206 is made from and the location in the prosthesis recipient's body where the microphone 200 will be implanted. In some embodiments, the diaphragm 206 is made from titanium or a titanium alloy. The diaphragm 206 can be made from other biocompatible materials as well.

The biocompatible housing 201 of the microphone 200 encloses a vibration sensor (not shown) configured to detect vibrations of the diaphragm 206. The microphone 200 generates electrical signals based at least in part on the vibrations of the diaphragm 206 detected by the vibration sensor. In some embodiments, the enclosed vibration sensor may be an electret microphone, an electromechanical microphone, a piezoelectric microphone, a micro-electromechanical system (MEMS) microphone, an accelerometer, an optical interferometer, a pressure sensor, or any other device now known of later developed that is configured to detect vibrations.

The vibrating structure 204 of the prosthesis recipient's body may be any vibrating structure in the recipient's middle or inner ear. For example, the vibrating structure 204 may be any of the recipient's eardrum, ossicles (including any of the malleus, incus, or stapes), oval window, round window, horizontal canal, posterior canal, or superior canal. A physician, surgeon, or other trained medical professional typically makes the determination of which inner or middle ear structure to mechanically couple to the first end 203 of the flexible elongate member 202. Typically, the determination is based on an analysis of the recipient's middle and ear structures and the recipient's hearing capabilities.

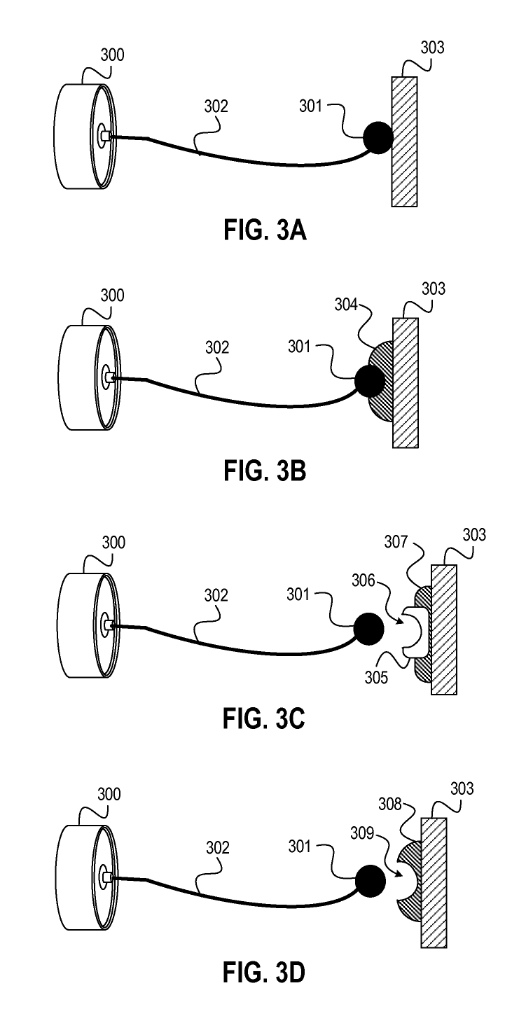

The mechanical coupling between the first end 203 of the flexible elongate member 202 and the vibrating structure 204 may be accomplished in a variety of ways. For example, in some embodiments, the first end 203 can be a surface-to-surface mechanical contact with perhaps a slight loading force to hold the first end 203 in place against the vibrating structure 204. In other embodiments, the first end 203 may be secured to the vibrating structure 204 with bone cement or another type of biocompatible adhesive. Different ways to mechanically couple the first end 203 of the flexible elongate member 202 to the vibrating structure 204 are shown and described with respect to FIGS. 3A-D.

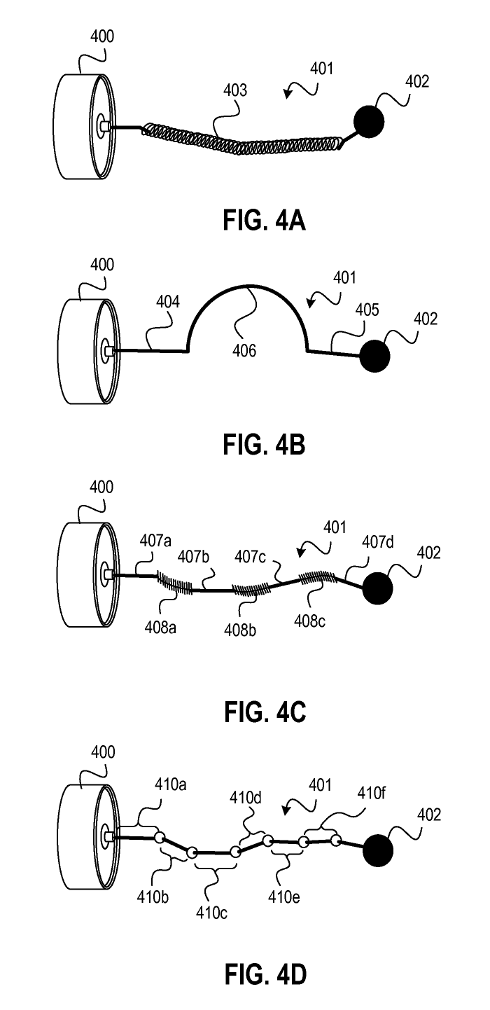

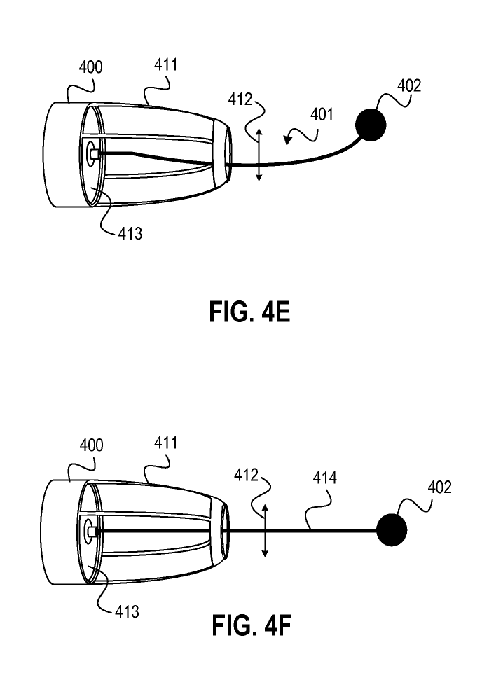

The flexible elongate member 202 shown with the example microphone 200 depicted in FIG. 2A is a straight or, as illustrated, partially curved wire. In some embodiments, the wire is titanium, a titanium alloy, or some other biocompatible metal. In other embodiments, the flexible elongate member 202 may be made from a different material, such as plastic, ceramic, glass, or other material. Although FIG. 2A shows the flexible elongate member 202 as a uniform (or at least partially uniform) wire, the flexible elongate member 202 may take other forms and configurations as well, including but not limited to, any of the forms or configurations shown and described in FIGS. 4A-E.

The flexible elongate member 202 of the microphone 200 is configured to transfer vibrations from the vibrating structure 204 to the diaphragm 206. Thus, the flexible elongate member 202 is sufficiently stiff to transfer vibration. However, in contrast to existing systems that employ rigid rods or other similar rigid structures, the flexible elongate member 202 is sufficiently flexible to bend and flex in response to forces applied thereto without causing damage to the diaphragm 206. Ideally, the flexible elongate member 202 exhibits a greater flexibility along a substantial portion of its length than a flexibility of the second portion 205 of the flexible elongate member 202 that is attached to the diaphragm 206.

In operation, elastic deformation of the flexible elongate member 202 in response to force (or forces) applied thereto minimizes any deformation of the diaphragm 206 and/or the second portion 205 (attaching the flexible elongate member 202 to the diaphragm 206) that would otherwise be caused by force (or forces) applied to a non-flexible elongate member. As a result, microphone 200 equipped with the flexible elongate member 202 is more robust and less prone to damage from the various forces encountered during manufacturing of the microphone 200, implantation of the microphone 200 into a recipient by a surgeon, and operation of the microphone 200 once implanted in the recipient's body. Additionally, in some embodiments, a microphone 200 configured with a flexible elongate member 202 may be fitted to a particular recipient's anatomy better than microphones with rigid rods or other similar structures. Different configurations of the flexible elongate member 202 for use with the microphone 200 are shown and described in more detail with respect to FIGS. 4A-E.

FIG. 2B shows an example of an actuator 207 with a flexible elongate member 202 for use with a direct acoustic stimulation prosthesis or perhaps another type of vibration-based prosthesis that utilizes a mechanical actuator. The actuator 207 may be at least partially implanted in the prosthesis recipient's body. In some embodiments, the actuator 207 is fully implanted within the recipient's body. The actuator 207 includes a biocompatible housing 208, a diaphragm 209, and a flexible elongate member 202 having a first end 203 and a second end 205. The first end 203 of the flexible elongate member 202 is mechanically coupled to a vibrating structure 204 of a prosthesis recipient's body and the second end 205 of the flexible elongate member 205 is secured to the diaphragm 209.

The diaphragm 209 of the actuator 207 is flexible and configured to vibrate. The thickness of the diaphragm 209 may be based on the material that the diaphragm 209 is made from and the location in the prosthesis recipient's body where the actuator 207 will be implanted. In some embodiments, the diaphragm 209 is made from titanium or a titanium alloy. The diaphragm 209 can be made from other biocompatible materials as well.

The actuator 207 is similar to the microphone 200 in many respects. However, one difference between the actuator 207 of FIG. 2B and the microphone 200 of FIG. 2A is that the biocompatible housing 208 of the actuator 207 encloses (among other things) a mechanical actuator mechanism configured to vibrate the diaphragm 209 of the actuator 207 whereas the biocompatible housing 208 of the microphone 200 encloses (among other things) a vibration sensor configured to detect vibrations of the diaphragm 206 of the microphone 200. Thus, the actuator 207 causes the vibrating structure 204 of the recipient's body to vibrate whereas the microphone 200 measures vibrations of the vibrating structure 204. The mechanical actuator mechanism enclosed within the biocompatible housing 208 of the actuator 207 may be any of a piezoelectric stack, a piezoelectric disc, a MEMS-based activator, or any other type of vibration-generating device now known or later developed.

The flexible elongate member 202 shown with the example actuator 207 depicted in FIG. 2B is a straight or partially curved wire. In some embodiments, the wire is titanium, a titanium alloy, or some other biocompatible metal. In other embodiments, the flexible elongate member 202 may be made from a different material, such as plastic, ceramic, glass, or other material. Although FIG. 2B shows the flexible elongate member 202 as a uniform (or at least partially uniform) wire, the flexible elongate member 202 may take other forms and configurations as well, including but not limited to, any of the forms or configurations shown and described in FIGS. 4A-E.

The flexible elongate member 202 of the actuator 207 is configured to transfer vibrations from the diaphragm 209 of the actuator 207 to the vibrating member 204 of the recipient's body. Although the flexible elongate member 202 is sufficiently stiff to transfer vibration, it is also sufficiently flexible to bend and flex in response to forces without causing damage to the diaphragm 209 of the actuator 207. Ideally, the flexible elongate member 202 exhibits a greater flexibility along a substantial portion of its length than a flexibility of the second portion 205 of the flexible elongate member 202 that is attached to the diaphragm 209.

In operation, elastic deformation of the flexible elongate member 202 in response to force (or forces) minimizes any deformation of the diaphragm 209 of the actuator 207 and/or the second portion 205 (attaching the flexible elongate member 202 to the diaphragm 209) that would otherwise be caused by force (or forces) applied to a non-flexible elongate member. As a result, the actuator 207 equipped with the flexible elongate member 202 is more robust and less prone to damage from the various forces encountered during manufacturing of the actuator 207, implantation of the actuator 207 into a recipient by a surgeon, and operation of the actuator 207 once implanted in the recipient's body. Additionally, in some embodiments, an actuator 207 configured with a flexible elongate member 202 may be fitted to a particular recipient's anatomy better than actuators with rigid rods or other similar structures. Different configurations of the flexible elongate member 202 for use with the actuator 207 are shown and described in more detail with respect to FIGS. 4A-E.

Mechanically Coupling an Elongate Member to a Vibrating Structure

FIGS. 3A-D show examples of mechanically coupling a flexible elongate member 302 to a vibrating structure 303 of a prosthesis recipient's middle or inner ear according to some embodiments. The mechanical couplings between the flexible elongate member 302 and the vibrating structure 303 shown and described with respect to FIGS. 3A-D may be used with a microphone (such as microphone 200 of FIG. 2A) or an actuator (such as actuator 207 of FIG. 2B). Each example shows a portion of a biocompatible housing 300 (of a microphone or an actuator) and a flexible elongate member 302 having a first end 301 mechanically coupled to a vibrating member 303 of a prosthesis recipient's body. As described above, the vibrating member 303 of the prosthesis recipient's middle or inner ear may be any of the recipient's eardrum, ossicles (including any of the malleus, incus, or stapes), oval window, round window, horizontal canal, posterior canal, or superior canal.

FIG. 3A shows a surface-to-surface mechanical contact between the first end 301 of the flexible elongate member 302 and the vibrating member 303. The first end 301 of the flexible elongate member 302 may be held in place against the vibrating member 303 with a slight loading force. In some embodiments, the loading force may be a force sufficient to keep the first end 301 in contact with the vibrating member 303 but less than a force that would meaningfully inhibit or restrict vibration of the vibrating member 303.

FIG. 3B shows the first end 301 of the flexible elongate member 302 secured to the vibrating structure 303 with a biocompatible adhesive 304. In some embodiments, the biocompatible adhesive 304 may be bone cement or another type of biocompatible bonding agent now known or later developed. During implantation, a surgeon may secure the first end 301 of the flexible elongate member 302 to the vibrating structure 303 with the biocompatible adhesive 304 so that the first end 301 of the flexible elongate member is physically attached or bonded to the vibrating structure 307.

FIG. 3C shows a fixture 305 comprising a socket 306 configured to mechanically receive the first end 301 of the flexible elongate member 302. The fixture 305 is secured to the vibrating structure 303 of the recipient's body with a biocompatible bonding agent 307, such as bone cement or any other type of biocompatible adhesive now known or later developed. The fixture 305 may be made from any of a number of biocompatible materials, such as titanium or titanium alloys, platinum, gold, ceramic, glass, or any other type of solid, biocompatible material now known or later developed. In some embodiments, the fixture 305 may enable the flexible elongate member 302 to transfer three-dimensional movements between the vibrating member 303 and a diaphragm, such as diaphragm 205 of the microphone 200 shown in FIG. 2A or diaphragm 209 of the actuator 207 shown in FIG. 2B.

FIG. 3D shows an alternative embodiment with a fixture 308 made from bone cement or other similar biocompatible material. The fixture 308 includes a socket 309 configured to mechanically receive the first end 301 of the flexible elongate member 302. During implantation, a surgeon may form the socket 309 by applying a layer of bone cement 308, pressing the first end 301 of the flexible elongate member 302 into the applied layer of bone cement 308, and removing the flexible elongate member 302 from the bone cement to leave an imprint of the first end 301 of the flexible elongate member 302 in the bone cement, thereby forming fixture 308. In some embodiments, the fixture 308 formed from the bone cement may enable the flexible elongate member 302 to transfer three-dimensional movements between the vibrating member 303 and a diaphragm, such as diaphragm 205 of the microphone 200 shown in FIG. 2A or diaphragm 209 of the actuator 207 shown in FIG. 2B.

In FIGS. 3A-D, the first end 301 of the flexible elongate member 302 includes a ball-shaped contact. However, in other embodiments, the first end 301 of the flexible elongate member 302 may include a contact having at least one flat surface, a U-shaped contact arranged to cup or at least partially surround at least a portion of the vibrating structure 303, or a contact that is specially-shaped to receive and/or interface with a particular vibrating structure 303 of the prosthesis recipient's body. Other types or shapes of contacts could be used as well depending on the shape and surface of the particular vibrating structure 303 to which the first end 301 of the flexible elongate member 302 is mechanically coupled.

Elongate Member Configurations

FIGS. 4A-F show example configurations of elongate members according to some embodiments. The flexible elongate members 401 shown and described with respect to FIGS. 4A-E may be used with a microphone (such as microphone 200 of FIG. 2A) or an actuator (such as actuator 207 of FIG. 2B). Likewise, the rigid elongate member 414 shown and described with respect to FIG. 4F may be used with a microphone (such as microphone 200 of FIG. 2A) or an actuator (such as actuator 207 of FIG. 2B).

Each example in FIGS. 4A-E shows a portion of a biocompatible housing 400 (of a microphone or an actuator) and a flexible elongate member 401 having a first end 402 that can be mechanically coupled to a vibrating structure of a prosthesis recipient's body. In each example, the first end 402 of the example flexible elongate member 401 can be mechanically coupled to the vibrating structure of the prosthesis recipient's body according to any of the mechanical coupling configurations shown and described with respect to FIGS. 3A-D. Similarly, in each example, the contact on the first end 402 of the example flexible elongate member 401 can take any of the forms previously described with respect to FIGS. 3A-D.

FIG. 4A shows an example embodiment where the flexible elongate member 401 includes a coil-shaped wire portion 403. During the implantation procedure, a surgeon can mechanically couple the first end 402 of the flexible elongate member 401 to a particular vibrating structure. The flexibility of the coil-shaped wire portion 403 allows the surgeon to position the flexible elongate member 401 as desired in the recipient's body. For example, the surgeon can route the flexible elongate member 401 around one or more structures (vibrating or non-vibrating) in the recipient's middle or inner ear to mechanically couple the flexible elongate member 401 to the desired vibrating structure within the recipient's ear. After the flexible elongate member 401 has been positioned by the surgeon as desired, the surgeon may at least partially fill at least some of the coils of the coil-shaped wire portion 403 with a biocompatible bonding agent. In operation, the bonding agent hardens or sets within the coils of the coil-shaped wire portion 403 thereby making the flexible elongate member 401 at least somewhat less flexible after the bonding agent has hardened than it was before the surgeon applied the bonding agent to the coils of the coil-shaped wire portion 403.

FIG. 4B shows an example embodiment where the flexible elongate member 401 includes a curved portion 406 joining a first straight portion 404 and a second straight portion 405. In some embodiments, each of the first straight portion 404, the curved portion 406, and the second straight portion 405 are flexible (or at least partially flexible). In alternative embodiments, one or more of the straight portions 404, 405 and the curved portion 406 is flexible (or at least partially flexible), and one or more of the straight portions 404, 405 and the curved portion 406 is rigid (or at least partially rigid). In some embodiments, the diameter of the wire forming the curved portion 406 may be less than the diameter of either (or both) of the wire forming the first straight portion 404 and the wire forming the second straight portion 405 to facilitate easier bending along the curved portion 406. In operation, the curved portion 406 allows the surgeon to position the flexible elongate member 401 as desired in the recipient's body. For example, the surgeon can position the flexible elongate member 401 so that the curved portion 406 routes the flexible elongate member 401 around one or more structures (vibrating or non-vibrating) in the recipient's body, so that the surgeon can mechanically couple the flexible elongate member 401 to the desired vibrating structure within the recipient's ear. Although the example embodiment shown in FIG. 4B has a single curved portion 406, other embodiments may include multiple curved portions.

FIG. 4C shows an example embodiment where the flexible elongate member 401 includes one or more rigid portions 407a-d and one or more flexible portions 408a-c. In operation, a surgeon may adjust the flexible portions 408a-c to position the flexible elongate member 401 in the recipient's body as desired. For example, the surgeon can adjust the flexible portions 408a-c to route the flexible elongate member 401 around one or more structures (vibrating or non-vibrating) in the recipient's middle or inner ear to mechanically couple the flexible elongate member 401 to the desired vibrating structure within the recipient's ear.

FIG. 4D shows an example embodiment where the flexible elongate member 401 includes a set of one or more interconnected adjustable portions 410a-f. In some embodiments, the interconnected adjustable portions 410a-f may include ball and socket joints. In other embodiments, the interconnected adjustable portions 410a-f may include hinges or other types of flexible joints. In operation, a surgeon may adjust the interconnected adjustable portions 410a-f to position the flexible elongate member 401 in the recipient's body as desired. For example, the surgeon can adjust the interconnected adjustable portions 410a-f to route the flexible elongate member 401 around one or more structures (vibrating or non-vibrating) in the recipient's middle or inner ear to mechanically couple the flexible elongate member 401 to the desired vibrating structure within the recipient's ear.

FIG. 4E shows an alternative embodiment where the biocompatible housing 400 (of a microphone or an actuator) has an external support structure 411 that at least partially encloses at least a portion of the flexible elongate member 401. In operation, the external support structure 411 is configured to limit radial movement 412 of the flexible elongate member 401 along a direction parallel to the face of the diaphragm 413. By limiting radial movement 412 of the flexible elongate member 412, the external support structure 411 reduces the risk of damage to the diaphragm 413 that may result from force (or forces) applied to the flexible elongate member along a direction parallel to the face of the diaphragm 413, for example, during implantation of the microphone (or actuator) in the recipient's ear and/or while positioning the flexible elongate member 401 during implantation. Thus, the protection against diaphragm damage provided by the external support structure 411 may, in some embodiments, compliment the protection against diaphragm damage provided by the flexibility of the flexible elongate member 401.

FIG. 4F shows another alternative embodiment where the biocompatible housing 400 (of a microphone or an actuator) has an external support structure 411. The embodiment shown in FIG. 4F is similar to the embodiment shown in FIG. 4E except that external support structure 411 is configured to at least partially enclose at least a portion of a rigid elongate member 414 instead of a flexible elongate member. A rigid elongate member may be advantageous in certain situations depending on the particular vibrating structure to which the elongate member is mechanically coupled and/or the location or positioning of the microphone or actuator in the recipient's body.

Like the flexible elongate members described elsewhere herein, the rigid elongate member 414 is configured to transfer vibrations between the diaphragm 413 and a vibrating structure (not shown) of the recipient's middle or inner ear that is mechanically coupled to a first end 402 of the rigid elongate member 414. One difference between the flexible elongate members described herein and the rigid elongate member 414 of FIG. 4F is that the rigid elongate member 414 does not possess the same degree of flexibility as the flexible elongate members. In many embodiments, all other aspects of the rigid elongate member (e.g., its material composition, the configuration of the mechanical coupling between the first end 402 and vibrating structure, etc.) are otherwise substantially the same as the flexible elongate members described herein.

Example Microphone Configurations

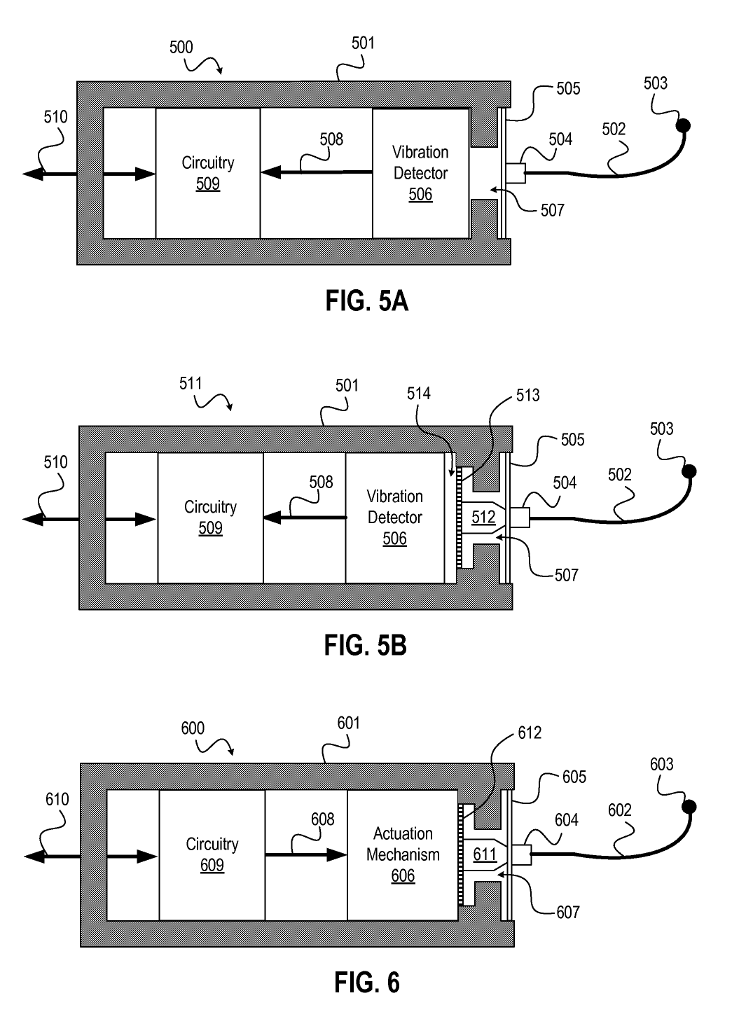

FIGS. 5A-B show cross-section views of example microphones 500, 511 according to some embodiments. The microphones 500, 511 shown in FIGS. 5A and 5B may be used with a prosthesis, such as the hearing prosthesis 101 shown and described with respect to FIG. 1. Additionally, the microphones 500, 511 may be similar to the microphones shown and described herein with respect to FIG. 2A.

FIG. 5A shows a cross-section view of a microphone 500 for use with a prosthesis such as the hearing prosthesis 101 shown and described with respect to FIG. 1. The microphone 500 includes a flexible elongate member 502 having a first end 503 mechanically coupled to a vibrating structure (not shown) of a prosthesis recipient's body and a second end 504 secured to a diaphragm 505. The diaphragm 505 may be similar to any of the diaphragms shown and described herein with respect to FIGS. 2-4. The flexible elongate member 502 is configured to transfer vibrations from the vibrating structure (not shown) to the diaphragm 505.

The flexible elongate member 502 of FIG. 5A may be similar to any of the flexible elongate members shown and described herein with respect to FIGS. 2-4. For example, the flexible elongate member 502 may be mechanically coupled to the vibrating structure (not shown) of the recipient's middle or inner ear via any of the mechanical coupling configurations shown and described with respect to FIGS. 3A-D, the first end 503 of the flexible elongate member 502 may include any of the contacts (ball-shaped, U-shaped, etc.) described with respect to FIGS. 3A-D, and the flexible elongate member 502 may be configured according to any of the example flexible elongate member configurations shown and described with respect to FIGS. 4A-E.

The microphone 500 also includes a vibration detector 506 and circuitry 509 enclosed within a biocompatible housing 501. The vibration detector 506 may be any of an electret microphone, an electromechanical microphone, a piezoelectric microphone, a MEMS microphone, an accelerometer, an optical interferometer, a pressure sensor, or any other type of vibration detector now known or later developed. A gas or liquid-filled chamber 507 exists between the diaphragm 505 and the vibration detector 506. For example, in embodiments where the vibration detector 506 is an electret microphone, MEMS microphone, accelerometer, or optical interferometer, the chamber 507 may be filled with gas such as helium or another gas. For embodiments where the vibration detector 506 is a piezoelectric microphone or pressure sensor, the chamber 507 may be filled with a liquid such as an oil, silicone gel, or other liquid. In operation, the vibration detector 506 is configured to detect vibrations of the diaphragm 505 and generate electrical signals based at least in part on the detected vibrations.

In some embodiments, electrical signals generated by the vibration detector 506 are sent to circuitry 509 via a wire 508 or other similar electrical connection mechanism. The circuitry 509 may include one or more discrete circuit components, one or more integrated circuits, and/or a special-purpose processor. In operation, the circuitry 509 is configured to prepare or condition the signal (e.g., amplification, etc.) for transmission to a sound processor, such as sound processor 104 shown and described with respect to FIG. 1. In some embodiments, the circuitry 509 is also configured to receive operating power from the hearing prosthesis for powering the microphone 500. In some embodiments, the microphone 500 may include a battery (not shown). In some embodiments, the circuitry 509 is also configured to send electrical signals generated by the vibration detector 506 to the sound processor via a communications link 510. The communications link 510 may be any type of wired or wireless communications link. The communications link 510 may also be used to provide operating power to the microphone 500 in some embodiments.

Although the example microphone 500 shown in FIG. 5A includes a flexible elongate member 502, alternative embodiments may instead utilize a rigid elongate member similar to the rigid elongate member 414 shown and described with respect to FIG. 4F. Additionally, some embodiments of the example microphone 500 may also include an external support structure similar to the external support structure 411 shown and described with respect to FIGS. 4E-F.

FIG. 5B shows a cross-section view of an alternative embodiment of a microphone 511 for use with a prosthesis such as hearing prosthesis 101 (FIG. 1). The microphone 511 shown in FIG. 5B includes many of the same elements as the microphone 500 shown and described in FIG. 5A. However, the microphone 511 of FIG. 5B includes an internal support structure 512 and a second diaphragm 513 that is not included in microphone 500.

Microphone 511 includes a flexible elongate member 502 having a first end 503 mechanically coupled to a vibrating structure (not shown) of a prosthesis recipient's body and a second end 504 attached to a first diaphragm 505. In operation, the flexible elongate member 502 is configured to transfer vibrations between the vibrating structure (not shown) and the first diaphragm 505 in a manner similar to the flexible elongate members described herein with respect to FIGS. 2-4. Microphone 511 also includes an internal support structure 512 mechanically coupled to the first diaphragm 505 and a second diaphragm 513. A first chamber 507 between the first diaphragm 505 and the second diaphragm 513 may be filled with a gas or a liquid, and a second chamber 514 between the second diaphragm 513 and the vibration detector 506 may also be filled with a gas or a liquid. For example, in embodiments where the vibration detector 506 is an electret microphone, MEMS microphone, accelerometer, or optical interferometer, the second chamber 514 may be filled with a gas such as helium or another gas. And for embodiments where the vibration detector 506 is a piezoelectric microphone or pressure sensor, the second chamber 514 may be filled with a liquid such as an oil, silicone gel, or other liquid. In operation, the vibration detector 506 is configured to detect vibrations of the second diaphragm 513, and generate electrical signals based at least in part on the detected vibrations.

In operation, the internal support structure 512 is configured to transfer vibrations between the first diaphragm 505 and the second diaphragm 513 while also limiting radial movement of the flexible elongate member 502 along a direction parallel to the face of the first diaphragm 505. In some embodiments, the second diaphragm 513 is a spring bearing configured to limit radial movement of the flexible elongate member 502. By limiting radial movement of the flexible elongate member 502, the internal support structure 512 reduces the risk of damage to the first diaphragm 505 or the second diaphragm 513 that may result from force (or forces) applied to the flexible elongate member 502 along a direction parallel to the face of the first diaphragm 505, for example, during implantation of the microphone 511 in the recipient's ear and/or while positioning the flexible elongate member 502 during implantation. Thus, the protection against damage to the first diaphragm 505 (and/or the second diaphragm 513) provided by the internal support structure 512 may, at least in some embodiments, compliment the protection against diaphragm damage provided by the flexibility of the flexible elongate member 502.

Although the example microphone 511 shown in FIG. 5B includes a flexible elongate member 502, alternative embodiments may instead utilize a rigid elongate member similar to the rigid elongate member 414 shown and described with respect to FIG. 4F. Additionally, some embodiments of the example microphone 511 may also include an external support structure similar to the external support structure 411 shown and described with respect to FIGS. 4E-F.

Example Actuator Configurations

FIG. 6 shows a cross-section view of an example actuator 600 according to some embodiments. The actuator 600 is configured for use with a direct acoustic stimulator prosthesis and may be similar to the actuator 207 shown and described herein with respect to FIG. 2A. The actuator 600 could alternatively be used with other types of vibration-based prostheses that utilize a mechanical actuator.

The actuator 600 includes a flexible elongate member 602 having a first end 603 mechanically coupled to a vibrating structure (not shown) of a prosthesis recipient's body and a second end 604 attached to a first diaphragm 605. The flexible elongate member 602 may be similar to any of the flexible elongate members shown and described herein with respect to FIGS. 2-4. For example, the flexible elongate member 602 may be mechanically coupled to the vibrating structure (not shown) of the recipient's middle or inner ear via any of the mechanical coupling configurations shown and described with respect to FIGS. 3A-D, the first end 603 of the flexible elongate member 602 may include any of the types of contacts (ball-shaped, U-shaped, etc.) described with respect to FIGS. 3A-D, and the flexible elongate member 603 may be configured according to any of the example flexible elongate member configurations shown and described with respect to FIGS. 4A-E.

In operation, the flexible elongate member 602 is configured to transfer vibrations from the first diaphragm 605 to the vibrating structure (not shown) of the recipient's middle or inner ear in a manner similar to the flexible elongate members described herein with respect to FIGS. 2-4. Actuator 600 also includes an internal support structure 612 mechanically coupled to the first diaphragm 605 and a second diaphragm 613. A chamber 607 between the first diaphragm 605 and the second diaphragm 613 may be filled with a gas or a liquid. Unlike the microphone 511 with the internal support structure 512 and second diaphragm 513 shown in FIG. 5A, the actuator 600 does not include a second chamber. Instead, an actuation mechanism 606 is physically coupled to the second diaphragm 612.

In operation, the actuation mechanism 606 enclosed within the biocompatible housing 601 is configured to generate vibrations based on signals received from a sound processor of the prosthesis. The vibrations generated by the actuation mechanism 606 are transferred to the second diaphragm 612, the internal support mechanism 611 transfers the vibrations of the second diaphragm 612 to the first diaphragm 605, and the flexible elongate member 602 transfers the vibrations of the first diaphragm 605 to the vibrating structure (not shown) of the recipient's middle or inner ear. The actuation mechanism 606 may be any of a piezoelectric stack, a piezoelectric disc, a MEMS-based activator, or any other type of vibration-generating device now known or later developed.

The internal support structure 612 is configured to transfer vibrations from the second diaphragm 612 to the first diaphragm 605 while also limiting radial movement of the flexible elongate member 602 along a direction parallel to the face of the first diaphragm 605. In some embodiments, the second diaphragm 612 is a spring bearing configured to limit radial movement of the flexible elongate member 602. By limiting radial movement of the flexible elongate member 602, the internal support structure 612 reduces the risk of damage to the first diaphragm 605 or the second diaphragm 612 that may result from force (or forces) applied to the flexible elongate member 602 along a direction parallel to the face of the first diaphragm 605, for example, during implantation of the actuator 600 in the recipient's ear and/or while positioning the flexible elongate member 602 during implantation. Thus, the protection against damage to first diaphragm 605 (or the second diaphragm 612) provided by the internal support structure 612 may, at least in some embodiments, compliment the protection against diaphragm damage provided by the flexibility of the flexible elongate member 602.

The actuator 600 also includes circuitry 609 enclosed within the biocompatible housing 601. The circuitry 609 may include one or more discrete circuit components, one or more integrated circuits, and/or a special-purpose processor. In operation, the circuitry 609 is configured to receive signals from a sound processor via a communications link 610. The communications link 610 may be any type of wired or wireless communications link. The communications link 610 may also be used to provide operating power to the actuator in some embodiments. In some embodiments, the actuator 600 may include a battery (not shown).

After receiving the signals from the sound processor, such as sound processor 104 shown and described with respect to FIG. 1, the circuitry 609 may condition and/or process the received signals (e.g., amplify, attenuate, demodulate, etc.), and send the conditioned and/or processed signals to the mechanical actuation mechanism 606 via connection 608. The mechanical actuation mechanism 606 in turn uses the signals from the circuitry 609 for generating the vibrations that are transferred to the vibrating structure via the flexible elongate member 602.

Although the example actuator 600 shown in FIG. 6 includes a flexible elongate member 602, alternative embodiments may instead utilize a rigid elongate member similar to the rigid elongate member 414 shown and described with respect to FIG. 4F. Additionally, some embodiments of the example actuator 600 may also include an external support structure similar to the external support structure 411 shown and described with respect to FIGS. 4E-F.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A prosthesis comprising:
a flexible elongate member having a first end mechanically coupled to a vibrating structure of a prosthesis recipient's body and a second end secured to a diaphragm, wherein the flexible elongate member is configured to transfer vibrations between the vibrating structure and the diaphragm.

2. The prosthesis of claim 1, further comprising:
a vibration sensor configured to detect vibrations of the diaphragm and generate electrical signals based at least in part on the detected vibrations.

3. The prosthesis of claim 2, wherein the vibration sensor comprises one of an electret microphone, an electromechanical microphone, a piezoelectric microphone, a MEMS microphone, an accelerometer, an optical interferometer, and a pressure sensor.

4. The prosthesis of claim 1, wherein the first end of the flexible elongate member includes a contact, wherein the contact comprises at least one of a ball-shaped contact, a flat contact, a U-shaped contact, and a contact shaped to receive the vibrating structure of the prosthesis recipient's body.

5. The prosthesis of claim 4, wherein the contact is secured to the vibrating structure of the recipient's body with a biocompatible bonding agent.

6-7. (canceled)

8. The prosthesis of claim 1, wherein the flexible elongate member comprises a coil-shaped flexible wire, and wherein at least a portion of the coil-shaped flexible wire is configured to receive a biocompatible bonding agent to reduce the flexibility of the flexible elongate member after the flexible elongate member has been positioned in the recipient's body.

9. The prosthesis of claim 1, wherein the flexible elongate member comprises wire.

10. The prosthesis of claim 1, wherein the flexible elongate member comprises at least one curved portion.

11-12. (canceled)

13. The prosthesis of claim 1, wherein the vibrating structure of the recipient's body is one of an eardrum, a malleus, an incus, a stapes, an oval window of the recipient's inner ear, a round window of the recipient's inner ear, a horizontal canal of the recipient's inner ear, a posterior canal of the recipient's inner ear, and a superior canal of the recipient's inner ear.

14. The prosthesis of claim 1, further comprising:
an output signal generator configured to generate output signals for application to the recipient, wherein the output signals are based on the electrical signals generated by the vibration sensor, and wherein the output signals comprise at least one of acoustic signals, electrical stimulation signals, and mechanical vibration signals.

15. The prosthesis of claim 1, further comprising:
an actuation mechanism configured to apply mechanical vibration signals to the vibrating structure of the recipient's body via the flexible elongate member by causing the diaphragm to vibrate, wherein the mechanical vibration signals are based on electrical signals received from a sound processor associated with the prosthesis.

16-20. (canceled)

21. The prosthesis of claim 1, wherein the second end of the flexible elongate member is directly connected to the diaphragm.

22. The prosthesis of claim 2, further comprising a chamber between the diaphragm and the vibration sensor, wherein the chamber is filled with one of a gas or a liquid.

23. A prosthesis comprising:
an elongate member having a first end configured for mechanically coupling to a vibrating structure of a prosthesis recipient's body and a second end connected to a diaphragm of the prosthesis, wherein the elongate member exhibits a greater flexibility along a first portion of its length than a flexibility of a second portion of its length.

24. The prosthesis of claim 23, wherein the length of the first portion of the elongate member is greater than the length of the second portion of the elongate member.

25. The prosthesis of claim 23, wherein the elongate member is configured to transfer vibrations between the vibrating structure and the diaphragm.

26. The prosthesis of claim 23, wherein the diaphragm is flexible and configured to vibrate.

27. The prosthesis of claim 23, wherein the diaphragm comprises at least of one of titanium or a titanium alloy.

28. The prosthesis of claim 23, wherein the second end of the elongate member is directly connected to the diaphragm.

29. The prosthesis of claim 23, further comprising:
a vibration sensor configured to detect vibration of the diaphragm and generate one or more signals based at least in part on the detected vibrations.

30. The prosthesis of claim 29, further comprising a chamber between the diaphragm and the vibration sensor, wherein the chamber is filled with one of a gas or a liquid.

31. The prosthesis of claim 29, wherein the vibration sensor comprises one of an electret microphone, an electromechanical microphone, a piezoelectric microphone, a MEMS microphone, an accelerometer, an optical interferometer, and a pressure sensor.

32. The prosthesis of claim 23, further comprising:
an actuation mechanism configured to cause the diaphragm to vibrate based at least in part on signals received from a sound processor associated with the prosthesis.

33. The prosthesis of claim 23, wherein the elongate member is sufficiently flexible to prevent deformation of the diaphragm in response to forces ordinarily applied to the elongate member during manufacturing, implantation, and operation of the prosthesis.

34. The prosthesis of claim 23, wherein elastic deformation of the elongate member in response to force ordinarily applied to the elongate member during manufacturing, implantation, and operation of the prosthesis minimizes risk of deformation of the diaphragm.
